(19) United States
(12) Patent Application Publication
(10) Pub. No.: US 2006/0055386 A1
(43) Pub. Date: Mar. 16, 2006

(54) Power factor improving circuit and control circuit for power factor improving circuit

(76) Inventor: Syohei Osaka, Niiza-shi (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/228,936

(22) Filed: Sep. 16, 2005

(30) Foreign Application Priority Data
Sep. 16, 2004 (JP) 2004-270139

(51) Int. Cl. G05F 1/40

(52) U.S. Cl. 323/282

(57) ABSTRACT

Mounted on an integrated circuit (41) of a power factor improving circuit are an error amplifier (40A) which outputs a difference voltage between a charged voltage in a capacitor (35) and a predetermined voltage, a timing setting circuit (40B) which sets timings at which a switching element (36) is switched on/off, a comparator (41e) and a switch (41f). When an instantaneous power failure occurs and the charged voltage in the capacitor (35) falls, the comparator (41e) detects the fall and causes the switch (41f) to be switched on. In response to this, a capacitor (42) is discharged and the difference voltage to be input to the timing setting circuit (40B) is reset to 0. When the power is recovered, the period in which the switching element (36) is switched on is shortened thereby suppressing over-rising of the charged voltage in the capacitor (35).

### BACKGROUND OF THE INVENTION

1. Field of the Invention

The present invention relates to a power factor improving circuit and a control circuit of a power factor improving circuit.

2. Description of the Related Art

FIG. 4 shows one example of a conventional power factor improving circuit 27.

The power factor improving circuit 27 converts an alternating-current (AC) power supplied from an AC power source 1 to a direct-current (DC) power, and supplies the DC power to a load 28. The power factor improving circuit 27 makes the power factor of the output power of the AC power source 1 almost “1”, by making the phase of the output current of the AC power source 1 coincide with the phase of the output voltage thereof.

The power factor improving circuit 27 comprises a full-wave rectifying circuit 2, an inductor 3, a diode 4, a capacitor 5, a switching element 6, a resistor 7, resistors 8 and 9, and a control circuit 10. The control circuit 10 comprises an error amplifier 11, a multiplier 12, a comparator 13, a driver circuit 14, and a reference voltage source 15. A capacitor 21 and an auxiliary power source 22 are connected to the control circuit 10. A charging circuit 23 is connected to the full-wave rectifying circuit 2 and the auxiliary power source 22.

The operation of the power factor improving circuit 27 shown in FIG. 4 will now be explained.

The full-wave rectifying circuit 2 full-wave-rectifies an AC voltage generated by the AC power source 1 to generate a rectified voltage. The rectified voltage is supplied to the capacitor 5 via the inductor 3 and the diode 4 to charge the capacitor 5. The switching element 6 is switched on and off by the driver 14. When the switching element 6 is switched on, a current (switching current) flows through the positive pole of the full-wave rectifying circuit 2, the inductor 3, the switching element 6, the resistor 7, and the negative pole of the full-wave rectifying circuit 2 in this order, and energy is stored in the inductor 3. The resistor 7 generates a voltage corresponding to the current value of the switching current. When the switching element 6 is switched off, the energy stored in the inductor 3 is supplied to the capacitor 5 via the diode 4. The capacitor 5 stores the supplied energy. The load 28 is supplied with a smoothed DC voltage Vo from the capacitor 5.

The resistors 8 and 9 divide the smoothed DC voltage Vo to generate voltage (voltage signal) Vd and supply the divided voltage Vd to the control circuit 10.

The error amplifier 11 in the control circuit 10 generates a difference voltage corresponding to the difference between a reference voltage Vref1 output from the reference power source 15 and the divided voltage Vd output from the resistors 8 and 9. The capacitor 21 functions as a phase compensation capacitor for the error amplifier 11. The multiplier 12 multiplies the difference voltage and the rectified voltage. The comparator 13 compares the voltage generated by the resistor 7 based on the switching current with the output voltage of the multiplier 12, and outputs an ON/OFF signal representing the comparison result.

The driver 14 controls the switching element 6 by a control signal to be switched on when an unillustrated detecting circuit detects that a current flowing through the inductor 3 becomes 0, and controls the switching element 6 to be switched off in response to the ON/OFF signal from the comparator 13, when the voltage generated by the resistor 7 is increasing and exceeds the output voltage of the multiplier 12.

In the power factor improving circuit 27 operating in the above-described way, the waveform of the current flowing into/from the power factor improving circuit 27 from/to the AC power source 1 becomes almost the same as the waveform of the output voltage of the AC power source 1, and their phases coincide. Accordingly, the power factor improving circuit 27 can supply a DC voltage Vo to the load 28 while maintaining the power factor of the output power of the AC power source 1 at almost “1”.

The auxiliary power source 22 is formed of, for example, a capacitor or the like. The auxiliary power source 22 is charged with part of the energy supplied from the AC power source 1 via a charging circuit 23. The control circuit 10 operates by the energy charged in the auxiliary power source 22.

Assume that the AC power source 1 stops due to, for example, a power failure of a commercial power source. In this case, if a sufficient amount of energy remains in the auxiliary power source 22, the control circuit 10 works properly. Meanwhile, since there is no charging voltage, the charged voltage Vo in the capacitor 5 falls. If the charged voltage Vo in the capacitor 5 falls, the difference voltage output from the error amplifier 11 becomes higher. As a result, the control circuit 10 controls the switching element 6 in a manner that the period (ON width) in which the switching element 6 is in the ON-state is the largest.

If the AC power source 1 continues to be stopped, the charged energy in the auxiliary power source 22 becomes extinct and the control circuit 10 stops operating.

Contrary to this, if the AC power source 1 is recovered to restart supplying the power while such an amount of energy as would enable the control circuit 10 to continue operating remains in the auxiliary power source 22, the switching element 6 is switched to be on for the largest ON width, immediately after the recovery of the AC power source 1. Therefore, the charged voltage Vo of the capacitor 5 drastically rises. This would cause the difference voltage output by the error amplifier 11 to fall. However, since the capacitor 21 is charged to a high voltage, the difference voltage is delayed from falling until capacitor 21 is discharged. Therefore, the charged voltage Vo of the capacitor 5 might become an overvoltage that exceeds the predetermined value.

Unexamined Japanese Patent Application KOKAI Publication No. H11-69785 discloses a power factor improving circuit which can prevent occurrence of such on overvoltage. This power factor improving circuit comprises an integrating circuit located between an input terminal of the error amplifier and a power source for generating a reference voltage , and a reset circuit which monitors the AC voltage generated by an AC power source and resets the output voltage of the integrating circuit to 0 when a power failure occurs. However, this power factor improving circuit needs to comprise the integrating circuit and the circuit for monitoring the AC voltage generated by the AC power source, resulting in a large circuit structure.

A power factor improving circuit disclosed in Unexamined Japanese Patent Application KOKAI Publication No. 2000-32743 comprises an overvoltage preventing circuit. This overvoltage preventing circuit suppresses the rise of the output voltage by keeping the switching element in the OFF-state when a resistor (corresponding to the resistor 8 shown in FIG. 4 of the present application) for detecting the DC voltage supplied to the load is disconnected from the output terminal of the power factor improving circuit. However, this overvoltage preventing circuit cannot suppress an over-rise of the DC output voltage that would be caused when the AC power source instantaneously recovers from a power failure.

### SUMMARY OF THE INVENTION

The present invention was made in view of the above circumstance, and an object of the present invention is to provide a power factor improving circuit which does not generate an overvoltage even after a power failure is cured.

Further, the present invention was made in view of the above circumstances, and another object of the present invention is to provide a power factor improving circuit of a small circuit scale, having a function of suppressing the rise of an output voltage after a power failure.

To achieve the above objects, a power factor improving circuit according to a first aspect of the present invention comprises:

a rectifying circuit (32) which rectifies an AC voltage generated by an AC power source to generate a rectified voltage;

an inductor (33) whose one end is connected to a positive pole of the rectifying circuit (32);

a rectifying element and a smoothing capacitor (34, 35) which are connected in series between the other end of the inductor (33) and a negative pole of the rectifying circuit (32);

a switching element (36) which is connected between the other end of the inductor (33) and the negative pole of the rectifying circuit (32) to be switched on/off, and which causes a switching current to flow from the positive pole into the inductor (33) to store energy in the inductor (33) when being switched on, while charging the stored energy in the smoothing capacitor (35) when being switched off;

an output voltage detecting circuit (38, 39) which generates a voltage signal (Vd) representing a charged voltage in the smoothing capacitor (35);

an error detecting circuit (40A) which detects a difference value between the voltage signal (Vd) and a first reference value (Vref1);

a difference value stabilizing capacitor (42) which restricts fluctuation of the difference value;

a timing setting circuit (40B) which sets a timing at which the switching element (36) is switched off, in a manner that the charged voltage becomes close to a predetermined voltage, based on the difference value; and

a reset circuit (40C) which compares the voltage signal (Vd) with a second reference value (Vref2), and resets the difference value to be input to the timing setting circuit (40B) to 0, in a case where the voltage signal (Vd) is lower than the second reference value (Vref2).

With this configuration, for example, in a case where a power failure occurs and the charged voltage in the smoothing capacitor (35) falls, the difference value to be input to the timing setting circuit (40B) is set to 0. When the power is recovered, the rectified voltage output by the rectifying circuit (32) is supplied to the smoothing capacitor (35) and energy based on the switching operation of the switching element (36) is also supplied to the smoothing capacitor (35), thereby causing the charged voltage in the smoothing capacitor (35) to rise.

Since the switching operation of the switching element (36) when the power is recovered is started substantially in a state where the difference value to be input to the timing setting circuit (40B) is almost 0, the charged voltage in the smoothing capacitor (35) does not drastically rise. Accordingly, even if the power failure is an instantaneous one (instantaneous power failure), the charged voltage in the smoothing capacitor (35) is prevented from over-rising by exceeding a predetermined voltage.

The reset circuit (40C) may set the difference value to 0 and stop the switching element (36) from being switched on/off, during a period in which the voltage signal (Vd) is lower than the second reference value (Vref2).

The error detecting circuit (40A), the timing setting circuit (40B), and the reset circuit (40C) may be integrated on a signal chip.

To achieve the above objects, a control circuit for a power factor improving circuit according to a second aspect of the present invention is incorporated in the power factor improving circuit including: a rectifying circuit which rectifies an AC voltage generated by an AC power source to generate a rectified voltage; an inductor whose one end is connected to a positive pole of the rectifying circuit; a rectifying element and a smoothing capacitor which are connected in series between the other end of the inductor and a negative pole of the rectifying circuit; and a switching element which is connected between the other end of the inductor and the negative pole of the rectifying circuit to be switched on/off for causing a switching current to flow from the positive pole into the inductor to store energy in the inductor when being switched on while charging the stored energy in the smoothing capacitor when being switched off, and comprises:

an error detecting circuit (40A) which detects a difference value between a voltage proportional to a charged voltage in the smoothing capacitor and a reference value (Vref1);

a difference value stabilizing capacitor (42) which restricts fluctuation of the difference value;

a timing setting circuit (40B) which sets a timing at which the switching element is switched off, in a manner that the charged voltage becomes close to a predetermined voltage, based on the difference value; and

a reset circuit (40C) which sets the difference value to be input to the timing setting circuit (40B) to 0, when the charged voltage in the smoothing capacitor does not a predetermined value.

The reset circuit (40C) may set the difference value to 0and stop the switching element from being switched on/off, during a period in which the proportional voltage is lower than a second reference value (Vref2).

The error detecting circuit (40A), the timing setting circuit (40B), and the reset circuit (40C) may be integrated on one chip, and the difference value stabilizing capacitor (42) may be externally attached to the chip.

According to the present invention, it is possible to prevent over-rising of the charged capacitor in the smoothing capacitor (35) which supplies a predetermined DC voltage to a load.

### BRIEF DESCRIPTION OF THE DRAWINGS

These objects and other objects and advantages of the present invention will become more apparent upon reading of the following detailed description and the accompanying drawings in which:

FIG. 1 is a diagram showing the configuration of a power factor improving circuit according to an embodiment of the present invention;

FIGS. 2A to 2G are waveform diagrams showing the behaviors of the power factor improving circuit of FIG. 1;

FIGS. 3A and 3B are waveform diagrams showing the behaviors of the power factor improving circuit of FIG. 1; and

FIG. 4 is a diagram showing the configuration of a conventional power factor improving circuit.

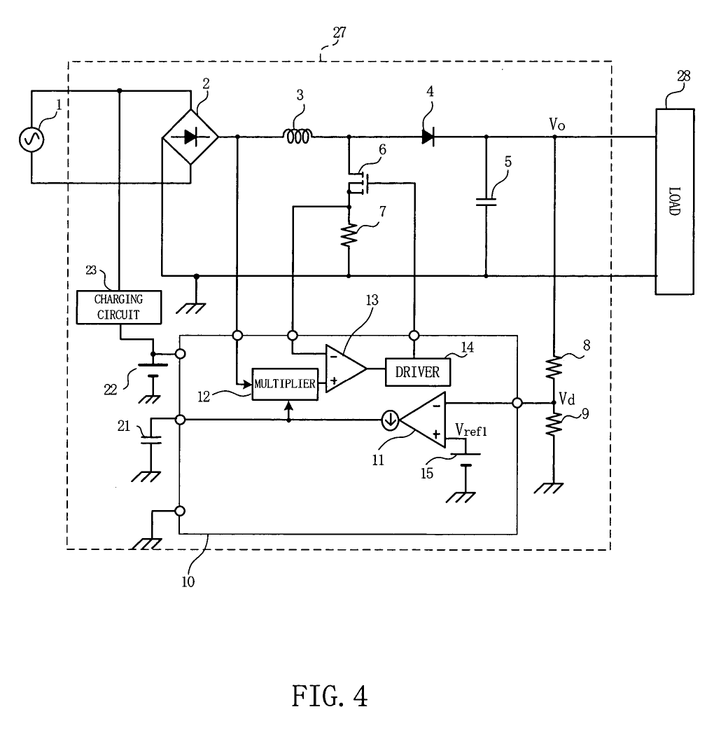

### DETAILED DESCRIPTION OF THE PREFERRED EMBODIMENT

A power factor improving circuit according to an embodiment of the present invention will now be explained with reference to the drawings.

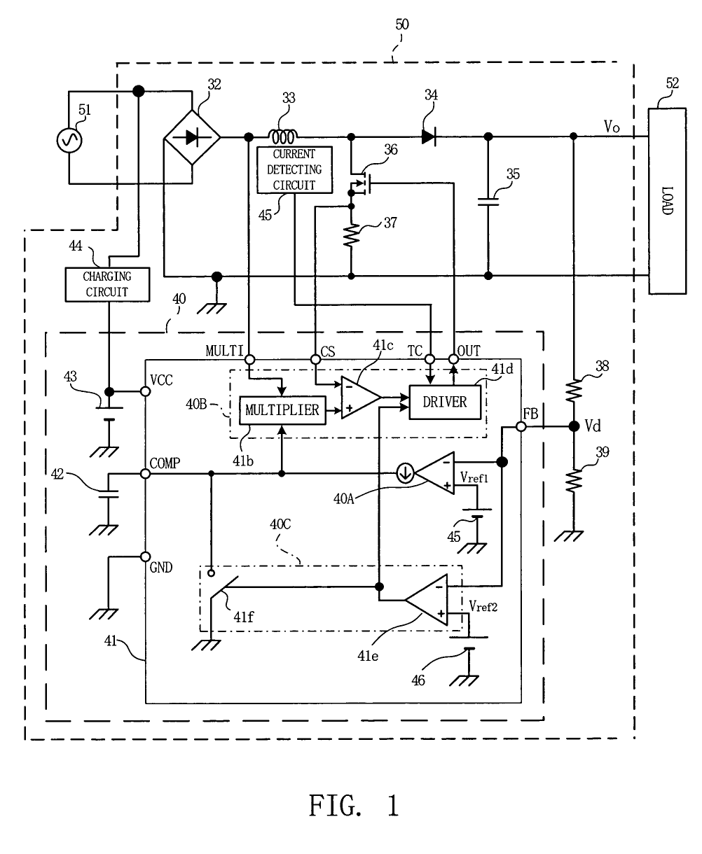

As shown in FIG. 1, a power factor improving circuit 50 according to the present embodiment is connected to an AC power source 51 and a load 52, and converts an AC power from the AC power source 51 to a DC power and supplies it to the load 52.

The power factor improving circuit 50 comprises a full-wave rectifying circuit 32, an inductor 33, a diode 34, a smoothing capacitor 35, a switching element 36, a resistor 37, resistors 38 and 39, a control circuit 40, a charging circuit 44, and a current detecting circuit 45.

The full-wave rectifying circuit 32 is formed of a diode bridge circuit or the like, and full-wave rectifies an AC voltage output from the AC power source 51 and outputs a rectified voltage.

The inductor 33 has its one end connected to the positive pole of the full-wave rectifying circuit 32.

The anode of the diode 34 is connected to the other end of the inductor 33. The smoothing capacitor 35 is connected between the cathode of the diode 34 and the negative pole of the full-wave rectifying circuit 32.

The switching element 36 is formed of an N-channel MOS transistor. The drain of the N-channel MOS transistor is connected to the other end of the inductor 33, the source thereof is connected to one end of the resistor 37 and the gate thereof is connected to a later-described driver 41d. The other end of the resistor 38 is connected to the negative pole of the full-wave rectifying circuit 32.

The resistors 38 and 39 are connected in series between the connection node between the cathode of the diode 34 and the capacitor 35, and the ground. The resistors 38 and 39 divide the output voltage Vo of the power factor improving circuit 50 (the charged voltage in the capacitor 35) to generate a voltage signal Vd having a voltage proportional to the output voltage Vo.

The charging circuit 44 charges a later-described auxiliary power source 43 by using an output voltage of the AC power source 51.

The current detecting circuit 45 is formed of a current transformer or the like, and outputs a detection signal when the current flowing through the inductor 33 becomes 0.

The control circuit 40 comprises a one-chip integrated circuit 41, and a capacitor 42 externally connected to the integrated circuit 41. The capacitor 42 stabilizes the output voltage of a later-described error amplifier 40A.

An FB terminal, a GND terminal, a VCC terminal, a COMP terminal, a MULTI terminal, a CS terminal, a TC terminal, and an OUT terminal are formed on the integrated circuit 41.

The FB terminal is connected to the connection node between the resistor 38 and the resistor 39, and the voltage Vd proportional to the charged voltage (=output voltage) Vo in the capacitor 35 is applied to the FB terminal. The GND terminal is connected to the ground. The capacitor 42 is connected between the COMP terminal and the ground. An auxiliary power source 43 for driving the control circuit 40 is connected to the VCC terminal. The auxiliary power source 43 comprises a capacitor and a secondary battery, and is charged by the charging circuit 44. The charging circuit 44 is connected to the AC power supply 51 (or the full-wave rectifying circuit 32). The auxiliary power source 43 is charged with part of the energy supplied from the AC power source 51 via the charging circuit 44. The MULTI terminal is connected to the positive pole of the full-wave rectifying circuit 32.

The integrated circuit 41 comprises an error amplifier 40A which works as an error detecting circuit. The inverting input terminal of the error amplifier 40A is connected to the FB terminal, and a first reference voltage Vref1 from a reference voltage generator 45 is input to the non-inverting input terminal of the error amplifier 40A. The error amplifier 40A outputs a voltage corresponding to the difference (Vref1-Vd) between the voltage Vd and the first reference voltage Vref1.

The output terminal of the error amplifier 40A is connected to the COMP terminal, and is also connected to one input terminal of a two-input multiplier 41b.

The other input terminal of the multiplier 41b is connected to the MULTI terminal.

The multiplier 41b multiplies the output voltage of the full-wave rectifying circuit 32 supplied via the MULTI terminal and the output voltage of the error amplifier 40A, and outputs the multiplied voltage.

The output terminal of the multiplier 41b is connected to the non-inverting input terminal (+) of a comparator 41c, and the inverting input terminal (−) of the comparator 41c is connected to the CS terminal. The voltage of the connection node between the switching element 36 and the resistor 37 is applied to the CS terminal.

The output terminal of the comparator 41c is connected to the first input terminal of a three-input driver 41d. The second input terminal of the driver 41d is connected to the current detecting circuit 45 via the TC terminal. The third input terminal of the driver 41d is connected to a later-described comparator 41e. The output terminal of the driver 41d is connected to the control terminal (gate electrode) of the switching element 36 via the OUT terminal. The multiplier 41b, the comparator 41c, and the driver 41d constitute a timing setting circuit 40B for setting the timing at which the switching element 36 is switched on and off.

A comparator 41e and a switch 41f are further formed on the integrated circuit 41.

The inverting input terminal (−) of the comparator 41e is connected to the FB terminal, and a second reference voltage Vref2 output from a reference voltage generator 46 is input to the non-inverting input terminal (+) of the comparator 41e. The output terminal of the comparator 41e is connected to the switch 41f and is also connected to the third input terminal of the driver 41d. The second reference voltage Vref2 is a voltage for determining whether a normal input voltage is input from the AC power source 51. The second reference voltage Vref2 is set to a lower value than that of the first reference voltage Vref1. The comparator 41e and the switch 41f constitute a reset circuit (40C) for resetting the difference value input to the multiplier 41b of the timing setting circuit 40B to 0.

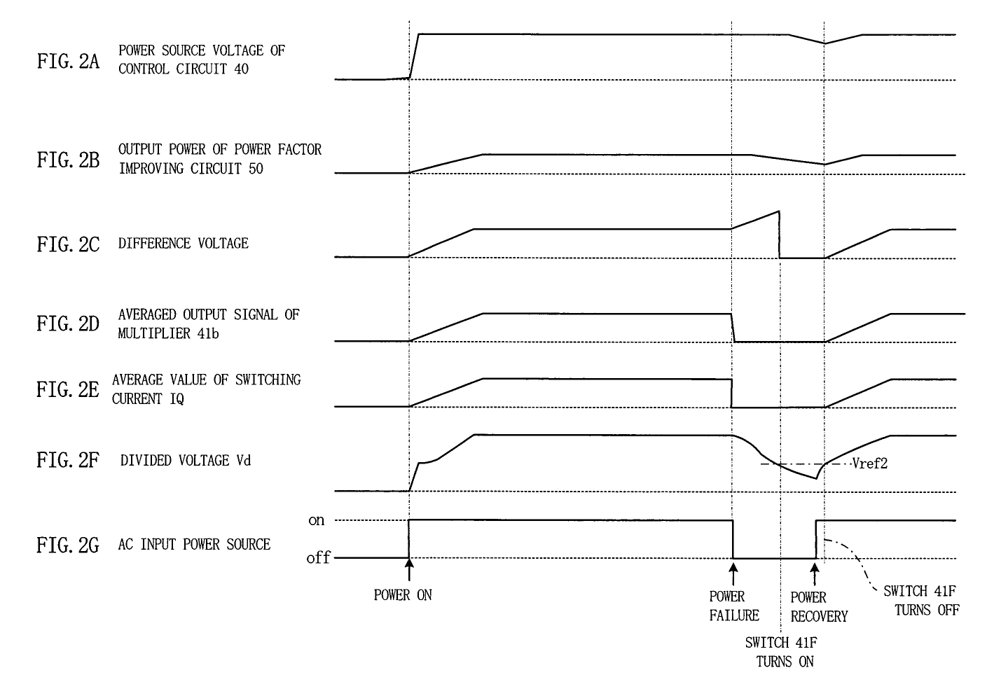

Next, the operation of the power factor improving circuit 50 will be explained with reference to the timing charts shown in FIGS. 2A to 2G.

When the AC power source 51 is turned on (power on) as shown in FIG. 2G, the power source voltage Vcc of the control circuit 40 is also turned on as shown in FIG. 2A. Then, the full-wave rectifying circuit 32 rectifies the AC voltage, and supplies the rectified voltage to the capacitor 35 via the inductor 33 and the diode 34. The charged voltage in the capacitor 35 drastically rises as shown in FIG. 2F.

Along with this, the output voltage Vo of the power factor improving circuit 50 also rises, and electric power is supplied to the load 52 from the capacitor 35 as shown in FIG. 2B. The resistors 38 and 39 generate a voltage Vd obtained by dividing the charged voltage in the capacitor 35 as shown in FIG. 2F. The error amplifier 40A outputs the difference signal having a difference voltage (Vref1-Vd) between the reference voltage Vref1 and the voltage Vd. The capacitor 42 is charged with the difference voltage and compensates the phase of the difference voltage to restrict its fluctuation. Accordingly, the difference voltage changes as shown in FIG. 2C.

The multiplier 41b multiplies the difference voltage by the rectified voltage generated by the full-wave rectifying circuit 32, and supplies a voltage signal corresponding to the product of the multiplication to the non-inverting terminal of the comparator 41c. The output of the multiplier 41b changes in accordance with the pulsation of the rectified voltage generated by the full-wave rectifying circuit 32. The average value of the output of the multiplier 41b is as shown in FIG. 2D.

The comparator 41c generates an OFF signal for switching off the switching element 36 and supplies it to the driver 41d, when the voltage generated by the resistor 37 is reducing and becomes equal to the voltage of the output signal of the multiplier 41b.

The driver 41d generates a control signal for controlling the switching element 36 to be switched on or off. The driver 41d controls the switching element 36 to be switched on in response to a detection signal from the current detecting circuit 45 representing that the current flowing through the inductor 33 becomes 0, and controls the switching element 36 to be switched off at a timing when it is supplied with the OFF signal from the comparator 41c.

By such a control being performed by the timing setting circuit 40B constituted by the multiplier 41b, the comparator 41c, and the driver 41d, it is possible to control a switching current IQ which coincides with the waveform of the rectified voltage to intermittently flow through the switching element 36, and to maintain the power factor at almost “1”.

By the switching current IQ flowing through the switching element 36, energy is stored in the inductor 33, and the stored energy is charged in the capacitor 35 via the diode 34 when the switching element 36 is in the OFF-state. That is, the control circuit 40 controls the switching element 36 to be switched on and off in a manner that the voltage generated by the resistors 38 and 39 becomes equal to the reference voltage Vref1, and makes the waveform of the input current which is intermittently input from the AC power source 51 via the full-wave rectifying circuit 32 similar to the waveform of the input voltage input via the full-wave rectifying circuit 32.

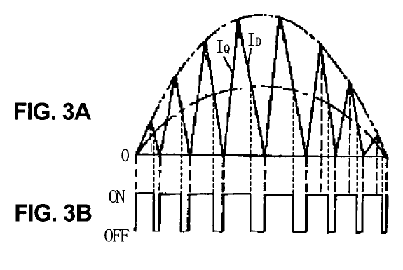

To be more specific, as a result of the timing setting circuit 40B repeating its control operation, the switching element 36 is switched on and off as shown in FIG. 3B, and the switching current IQ flows through the switching element 36 and a charging current ID flows through the diode 34 as shown in FIG. 3A. Because of this, the waveform of the average input current becomes as indicated by the dashed line in FIG. 3A, and the power factor becomes very close to “1”.

Assume that an instantaneous power failure occurs as shown in FIG. 2G. By the power failure, the rectified voltage of the full-wave rectifying circuit 32 becomes 0, and the charged voltage in the capacitor 35 falls. This causes the voltage Vd generated by the resistors 38 and 39 to fall as shown in FIG. 2F, and causes the difference value output by the error amplifier 40A to rise as shown in FIG. 2C.

When the voltage Vd falls below the reference voltage Vref2, the comparator 41e detects the fall, and outputs a voltage fall signal representing that the voltage Vd falls below the reference voltage Vref2 to the switch 41f and the driver 41d.

When supplied with the voltage fall signal, the switch 41f is switched on. When the switch 41f is switched on, the COMP terminal is connected to a grand and the capacitor 42 is discharged, and the difference voltage is reset to 0 as shown in FIG. 2C. The output signal of the multiplier 41b is also set to 0. Further, the driver 41d stops switching on and off the switching element 36 in response to the voltage fall signal and continues stopping during the period in which the voltage fall signal is being supplied.

Next, when the power supply is recovered, the rectified voltage of the full-wave rectifying circuit 32 rises, and this raises the charged voltage in the capacitor 35 and the voltage Vd of the resistors 38 and 39.

When the voltage Vd exceeds the reference voltage Vref2, the comparator 41e stops outputting the voltage fall signal and the switch 41f is switched off accordingly.

The reference voltage Vref2 is a reference value to be compared with he voltage Vd in order to determine whether a normal AC voltage has been input or not. In a case where the voltage Vd is lower than the reference voltage Vref2, the switch 41f is in the ON-state and the switching on/off operation of the switching element 36 is stopped.

Contrary to this, the reference voltage Vref1 is a reference value for controlling the charged voltage in the capacitor 35, as the output voltage of the power factor improving circuit 50, to be a predetermined target voltage. The reference voltage Vref1 is set to a value obtained by dividing of the predetermined target voltage by the resistors 38 and 39.

If the reference voltage Vref2 is set to a value close to the reference voltage Vref1, the switch 41f remains switched on when the power factor improving circuit 50 becomes actuated, thereby hindering the switching operation of the switching element 36 and possibly causing an actuation fault. Hence, the reference voltage Vref2 is set to a voltage slightly lower than the value obtained by rectifying and smoothing the lower limit value of a normal AC voltage supplied from the AC power source 51 and then the resistors 38 and 39 dividing the rectified and smoothed value.

When the switch 41f is changed from the On-state to the OFF-state, the switching on/off of the switching element 36 is started in a state of the charged voltage in the capacitor 42 being 0, and the level of the output signal of the error amplifier 40A rises while the capacitor 42 is charged with this output signal. Therefore, the ON width of the switching element 36 does not drastically broaden, and the charged voltage in the capacitor 35 does not drastically rise. As a result, the charged voltage in the capacitor 35 is prevented from over-rising.

According to the power factor improving circuit 50 of the present embodiment operating in the above-described manner, it is possible to prevent over-rising of the charged voltage in the capacitor 35 when the power is recovered after an instantaneous power failure. Therefore, the load 52 and the elements in the power factor improving circuit 50 are saved from being overstressed. Further, even if the resistor 38 is disconnected from the capacitor 35 or the output terminal of this power factor improving circuit 50 due to some cause, the comparator 41e detects this so that the driver 41b will stop the switching on/off of the switching element 36. Accordingly, the capacitor 35 is almost free from its charged voltage over-rising. Further, the power factor improving circuit 50 of the present invention does not need terminals or circuits that are needed in the integrated circuit unit 41 included in the control circuit 40 of the power factor improving circuit of Patent Document 1, in order to detect the AC voltage of the AC power source. Accordingly, it is possible to simplify the structure of the power factor improving circuit and to reduce factors of defects such as mistakes in laying wires.

The present invention is not limited to the above-described embodiment, but can be modified in various manners.

For example, the switching element 36 may be formed of a bipolar transistor, other than a MOS transistor.

Further, the switching element 36 may be switched and or off at a fixed frequency, and the current flowing through the inductor 33 may be operated in continuous mode. Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A power factor improving circuit, comprising:
a rectifying circuit (32) which rectifies an AC voltage generated by an AC power source to generate a rectified voltage;
an inductor (33) whose one end is connected to a positive pole of said rectifying circuit (32);
a rectifying element and a smoothing capacitor (34, 35) which are connected in series between the other end of said inductor (33) and a negative pole of said rectifying circuit (32);
a switching element (36) which is connected between the other end of said inductor (33) and the negative pole of said rectifying circuit (32) to be switched on/off, and which causes a switching current to flow from the positive pole into said inductor (33) to store energy in said inductor (33) when being switched on, while charging the stored energy in said smoothing capacitor (35) when being switched off;
an output voltage detecting circuit (38, 39) which generates a voltage signal (Vd) corresponding to a charged voltage in said smoothing capacitor (35);
an error detecting circuit (40A) which detects a difference value between the voltage signal (Vd) and a first reference value (Vref1);
a timing setting circuit (40B) which sets a timing at which said switching element (36) is switched off, in a manner that the charged voltage becomes close to a predetermined voltage, based on the difference value; and
a reset circuit (40C) which compares the voltage signal (Vd) with a second reference value (Vref2), and suppresses the difference value to be input to said timing setting circuit (40B) in a case where the voltage signal (Vd) is lower than the second reference value (Vref2).

2. The power factor improving circuit according to claim 1, wherein said reset circuit (40C) sets the difference value to be input to said timing setting circuit (40B) to 0, in the case where the voltage signal (Vd) is lower than the second reference value (Vref2).

3. The power factor improving circuit according to claim 1, wherein said reset circuit (40C) sets the difference value to 0 and stops said switching element (36) from being switched on/off, during a period in which the voltage signal (Vd) is lower than the second reference value (Vref2).

4. The power factor improving circuit according to claim 1, further comprising a difference value stabilizing capacitor (42) which is connected to an output end of said error detecting circuit (40A) in order to restrict fluctuation of the difference value.

5. The power factor improving circuit according to claim 1, wherein said error detecting circuit (40A), said timing setting circuit (40B), and said reset circuit (40C) are integrated on a signal integrated circuit.

6. The power factor improving circuit according to claim 1, wherein said output voltage detecting circuit (38, 39), said error detecting circuit (40A), said timing setting circuit (40B), and said reset circuit (40C) comprise an auxiliary power source (43) which supplies power to them for a predetermined period even when power supply from said AC power source is stopped.

7. A control circuit for a power factor improving circuit incorporated in said power factor improving circuit including a rectifying circuit which rectifies an AC voltage generated by an AC power source to generate a rectified voltage, an inductor whose one end is connected to a positive pole of said rectifying circuit, a rectifying element and a smoothing capacitor which are connected in series between the other end of said inductor and a negative pole of said rectifying circuit, and a switching element which is connected between the other end of said inductor and the negative pole of said rectifying circuit to be switched on/off for causing a switching current to flow from the positive pole into said inductor to store energy in said inductor when being switched on while charging the stored energy in said smoothing capacitor when being switched off, said control circuit (40) comprising:
an error detecting circuit (40A) which detects a difference value between a voltage proportional to a charged voltage in said smoothing capacitor and a reference value (Vref1);
a timing setting circuit (40B) which sets a timing at which said switching element is switched off, in a manner that the charged voltage becomes close to a predetermined voltage, based on the difference value; and
a reset circuit (40C) which sets the difference value to be input to said timing setting circuit (40B) to 0, when the charged voltage in said smoothing capacitor does not a predetermined value.

8. The control circuit for said power factor improving circuit according to claim 7, wherein said reset circuit (40C) sets the difference value to 0 and stops said switching element from being switched on/off, during a period in which the proportional voltage is lower than a second reference value (Vref2).

9. The control circuit for said power factor improving circuit according to claim 7, wherein said error detecting circuit (40A), said timing setting circuit (40B), and said reset circuit (40C) are integrated on one chip, and a difference value stabilizing capacitor (42) which restricts fluctuation of the difference value is externally attached to said chip.
